(19) United States
(12) Patent Application Publication
(10) Pub. No.: US 2006/0286151 A1
(43) Pub. Date: Dec. 21, 2006

(54) Production of foie gras

(76) Inventor: Robert Bender, Ottawa (CA)

Correspondence Address: LAHIVE & COCKFIELD, 28 STATE STREET, BOSTON, MA, 02109, US

(21) Appl. No.: 11/412,714

(22) Filed: Apr. 27, 2006

Related U.S. Application Data
(60) Provisional application No. 60/675,830, filed on Apr. 27, 2005.

(51) Int. Cl. A23K 1/165

(52) U.S. Cl. 424/442

(57) ABSTRACT

Feed and methods for changing composition and increasing liver size of poultry are discussed.

### RELATED APPLICATIONS

This application claims priority to U.S. Provisional Patent Application Ser. No. 60/675,830, filed Apr. 27, 2005, the entire contents of which are hereby incorporated herein by reference.

### BACKGROUND OF THE INVENTION

Hepatic steatosis in ducks and geese is of positive economic value and serves as the basis for the production of “foie gras.” The “foie gras” industry is based on, at least in part, on overfeeding and, to a large extent, force-feeding of poultry. In nature, hepatic steatosis is seen as a pre-migration response of waterfowl which have access to abundant feed and gorge themselves to increase their stored energy reserves.

First observed as a natural phenomenon by hunters (as far back as the time of the Pharaohs) and prized as a delicacy, “foie gras” production has developed as a part of traditional and industrial farming. In practice, it is achieved by force-feeding ducks (and geese) for 10-20 days when the animals are close to market weight. The force feeding is usually done with a slurry feed administered by gavage and this requires intensive handling of animals and a high level of operator skill. Foie gras is therefore intrinsically expensive due to high labor inputs as well as significant animal mortality due to improperly administered gavages. In recent years, there has been a significant backlash against foie gras (in the United States) lead by animal rights activists. Diets for the production of foie gras are traditionally high-energy diets which are deficient in choline and which have been found to promote hepatic steatosis if fed in high quantities via gavage. The agricultural tradition on which foie gras production is based has created technical stasis based on success.

### SUMMARY OF THE INVENTION

In one embodiment, the invention pertains, at least in part, to a method for changing liver composition and increasing liver size in poultry. The method includes administering to the poultry a feed containing a sufficiently low amount of nitrogen containing compounds, e.g., amino acids and protein, such that liver composition is changed and liver size in the poultry is increased.

In one embodiment, the invention pertains, at least in part, to a method for changing composition and increasing liver size in poultry. The method includes administering to poultry a feed comprising an effective amount of carbohydrates and triglycerides or other lipids, such that liver composition is changed and generally the livers size increased, wherein the feed comprises a sufficiently low amount of protein and amino acids.

In a further embodiment, the invention pertains to a poultry feed, wherein the poultry feed is comprised of at least about 5-10% by weight lipids and essentially no protein or amino acids.

In a further embodiment, the poultry are housed in an artificially lit environment where photoperiod is controlled and modified so as to induce some of the physiological changes which are associated with migration.

In a further embodiment the poultry are briefly subjected to calorie restriction prior to being placed on the poultry feed of the invention.

In another further embodiment, the invention also pertains to an isolated poultry liver. In this embodiment, the poultry liver of the invention is from a poultry which had been feed a feed containing a sufficiently low amount of nitrogen containing compounds, such as protein or amino acids.

### DETAILED DESCRIPTION OF THE INVENTION

In growing birds, the major transporter of triglycerides are VLDL. When hepatic lipogenesis exceeds the capacity of VLDL secretion, triglycerides accumulate in the liver. Lipids, and especially triglycerides, may be stored in hepatocytes as well as adipocytes. Commercial avian feeds are usually relatively low in lipids and high in carbohydrates and protein. See, for example, Poultry Production, M. C. Nesheim et al. (Lea & Febiger, Philadelphia: 1979); Nutrition and Management of Ducks, M. L. Scott et al. (M. L. Scott, Ithaca, N.Y.:1991); Nutrient Requirements of Poultry, National Research Council (National Academy Press, Washington, D.C.: 1994). Each of these publications is incorporated herein by reference.

The present invention relates to the discovery that by eliminating or sharply reducing protein and increasing the triglyceride content of poultry feed, while optionally and simultaneously modifying the photoperiod and energy intake, the natural migration response can be triggered so as to result in rapid absorption and storage of triglycerides in the hepatocytes, as well as, significant deposition of the storage carbohydrate, glycogen, in the liver. In poultry, the intestinal digestion of lipids involves their partial hydrolysis, absorption and reassembly in the intestinal mucosal cells. They are then secreted as very large lipoprotein particles and deposited in the liver. In nature and in general agricultural practice, poultry consume diets low (less than 5%) in fat and substantially all triglyceride synthesis in poultry takes place in the liver (from carbohydrate sources), in contrast to most mammals where significant fat synthesis takes place in adipose tissue. Conditions for hepaptic steatosis are favored by high carbohydrate intake and low protein since export of fats from the hepatocytes is dependent on protein synthesis. During migration, where abundant food supplies are episodically available, ‘foie gras’ production is an adaptive response to the opportunity to take on a high-energy reserve rapidly.

According to the present invention, foie gras formation (e.g., enhanced lipid and/or lipoprotein content of the liver and/or enhanced liver size), can be achieved without force feeding and by the agency of a diet high in fat, starch (or other suitable carbohydrate) and depleted in protein together with optimization of physiological responses conditioned by programmed feeding and photoperiodicity.

Induction of the foie gras formation may be facilitated by withdrawing the poultry form all food for 12-36 hours before giving as lib access to a palatable diet high in fat and carbohydrates. The withdrawal of feed may facilitate the shift to a “storage economy” from a growth regimen.

Induction of foie gras formation may also be facilitated by manipulation of photoperiodicity to mimic the natural seasonality of the migration responses. In a further embodiment, the photoperiodicity is manipulated for at least 1, 2, 3, 4, 5, 6, or 7 days or longer. In a further embodiment, the photoperiodicity is manipulated to simulate decreasing, or alternatively, decreasing day length.

In one embodiment, the invention pertains, at least in part, to a method for changing liver composition and increasing liver size in poultry. The method includes administering to the poultry a feed containing a sufficiently low amount of nitrogen containing compounds, e.g., amino acids and protein, such that liver composition is changed and liver size in the poultry is increased.

In another embodiment, the invention pertains, at least in part, to a method for changing composition and increasing liver size in poultry. The method includes administering to poultry a feed comprising an effective amount of fats, e.g., lipids, e.g., triglycerides, such that liver size in the poultry is increased, wherein the feed comprises a sufficiently low amount of protein.

In a further embodiment, the invention pertains to a poultry feed, wherein the poultry feed is comprised of at least about 10% by weight lipids and a sufficiently low amount of protein. In a further embodiment, the sufficiently low amount of lipids is sufficiently low enough to allow for an increase in liver size of the poultry and/or a change in the liver composition.

In a further embodiment, the poultry feed is comprised by about 15% or greater lipids, about 20% or greater lipids, about 25% or greater lipids, about 30% or greater lipids, about 35% or greater lipids, about 40% or greater, about 50% or greater lipids by weight.

In a further embodiment, the poultry feed comprises about 10% or greater carbohydrates, about 20% or greater, about 30% or greater, about 40% or greater, or about 50% or greater, about 60% or greater, about 70% or greater, or about 80% or greater carbohydrates by weight.

The term “sufficiently low” refers to an amount of protein and/or other nitrogen containing compounds in the poultry feed which allows for the liver of the poultry to change in size and/or composition when administered in combination with the carbohydrates and fats as described above. In a further embodiment, the sufficiently low amount is essentially no protein and/or other nitrogen containing compounds such as amino acids. The term “essentially no” includes levels of protein and amino acids of about 5% or less, about 4% or less, about 3% or less, about 2% or less, about 1% or less, about 0.5% or less, about 0.25% or less or about 0.1% or less of protein and/or amino acids by weight.

The poultry feed may also contain vitamins and minerals necessary for poultry health. It also may contain appropriate carriers and other fillers known in the art to be appropriate for poultry feed.

In a further embodiment, the feed may contain fatty acids, such as omega-3 fatty acids. The omega-3 fatty acids may then be incorporated into the storage triglycerides in the liver of the poultry. The foie gras produced from such feed may be high in omega-3 fatty acids and have perceived consumer health attributes. The feed may also be manipulated to incorporate flavor agents as lipids or as compounds which are highly fat soluble and the partition into the hepatic fat depot in the liver of the poultry.

The term “poultry” includes individual birds and multiple birds such as, for example, chickens, guinea hens, and, preferably, ducks and geese.

The term “effective amount” is the amount necessary to increase liver size, and/or change its composition by accumulate triglycerides, lipoproteins, lipids, and/or carbohydrates in the liver. In a further embodiment, the effective amount is effective to increase the liver size of said poultry by about 5% or greater, 10% or greater, 15% or greater, 25% or greater, 30% or greater, 35% or greater, 40% or greater, 45% or greater, 50% or greater, 55% or greater, 60% or greater, 70% or greater, 80% or greater, 90% or greater, 100% or greater, 150% or greater, 200% or greater, or by 250% or greater, as compared to the liver size of said poultry prior to administration of the feed.

In a further embodiment, the feed is administered to the poultry without force feeding, e.g., without the use of a gavage or other forceful feeding device. In a further embodiment, the feed is administered to the poultry ad litum. In a further embodiment, the method includes withdrawing the poultry from all feed for about 12 to about 36 hours prior to administering to said poultry the feed of the invention. In a further embodiment the method includes manipulation of photoperiodicity to stimulate physiological changes of the migration response and in a further embodiment the combination of induction factors as described above.

In another embodiment, the invention also pertains to an isolated poultry liver. The poultry liver, of this embodiment, is from a poultry which had been feed a feed containing a sufficiently low amount, e.g., substantially free, of protein and/or amino acids, such that the liver of the poultry was changed in composition and increased in size prior to removal of the liver and/or death of the poultry. In a further embodiment, the poultry is feed the substantially protein and amino acid-free feed for at least about two days, about three days, about four days, about five days, about six days, about seven days, or about eight days or longer, before its death and/or removal of its liver. In another further embodiment, the poultry is feed the feed exclusively for a period of time prior to its death and/or removal of its liver.

The term “isolated” includes any removal of the liver from the poultry source. The isolated poultry liver may be further cooked, processed or mixed with other substances.

### EXAMPLES

### Example 1

An example of the composition of a duck feed of the invention is shown below in Table 1:

TABLE 1

| | Duck Feed |
|---|---|
| Nutrient | of the Invention |
| Protein | <1% |
| Fat | <10% |
| Carbohydrates | >80% |
| Customary trace and minor nutrients as in | balance |
| a normal feed composition | |

### Example 2

An example of the composition of a duck feed of the invention is shown below in Table 2:

TABLE 2

| | Duck Feed |
|---|---|
| Nutrient | of the Invention |
| Protein | <0.1% |
| Fat | <10% |
| Carbohydrates | >80% |
| Customary trace and minor nutrients as in | balance |
| a normal feed composition | |

### Example 3

### Sample Duck Feed of the Invention

An example of the composition of a duck feed of the invention is shown below in Table 3:

TABLE 3

| | Duck Feed |
|---|---|
| Nutrient | of the Invention |
| Protein % | <1 |
| Calcium % | 1 |
| Fat % | 10 |
| Carbohydrates % | 80 |
| Phosphorous % | 0.4 |
| Manganese mg/kg | 50 |
| Niacin mg/kg | 40 |
| Pantothenic acid mg/kg | 10 |
| Pyridoxine mg/kg | 3 |
| Riboflavin mg/kg | 6 |
| Vitamin A mg/kg | 1720 |
| Vitamin D3 mg/kg | 22.5 |
| Vitamin K mg/kg | 2 |

### Example 4

### Sample Duck Feed of the Invention

An example of the composition of a duck feed of the invention is shown below in Table 4:

TABLE 4

| | Duck Feed |
|---|---|
| Nutrient | of the Invention |
| Protein % | <0.1 |
| Calcium % | 1 |
| Fat % | 10 |
| Carbohydrates % | 80 |
| Phosphorous % | 0.4 |
| Manganese mg/kg | 50 |
| Niacin mg/kg | 40 |
| Pantothenic acid mg/kg | 10 |
| Pyridoxine mg/kg | 3 |
| Riboflavin mg/kg | 6 |
| Vitamin A mg/kg | 1720 |
| Vitamin D3 mg/kg | 22.5 |
| Vitamin K mg/kg | 2 |

Equivalents

Those skilled in the art will recognize, or be able to ascertain using no more than routine experimentation, many equivalents to the specific embodiments and methods described herein. Such equivalents are intended to be encompassed by the scope of the following claims. The entire contents of all references and patents cited herein are hereby incorporated by reference.

1. A method for changing liver composition and increasing liver size in poultry, comprising:
administering to said poultry a feed containing a sufficiently low amount of proteins and amino acids, such that liver composition is changed and liver size in said poultry is increased.

2. The method of claim 1, wherein said poultry are ducks or geese.

3. The method of claim 1, wherein said feed comprises not more than about 1% protein and amino acids by weight.

4. The method of claim 1, wherein said feed comprises not more than about 0.5% protein and amino acids by weight.

5. The method of claim 4, wherein said feed comprises not more than about 0.1% protein and amino acids by weight.

6. The method of claim 1, wherein said poultry are feed a sufficiently low amount of protein and amino acids for at least twenty four hours.

7. The method of claim 6, wherein said poultry are feed a sufficiently low amount of protein and amino acids for at least two days.

8. The method of claim 7, wherein said poultry are feed a sufficiently low amount of protein and amino acids for at least four days.

9. The method of claim 8, wherein said poultry are feed a sufficiently low amount of protein and amino acids for at least one week.

10. A method for changing liver composition and increasing liver size in poultry, comprising:
administering to said poultry a feed comprising an effective amount of carbohydrates and fat, such that liver composition is changed and liver size in said poultry is increased, wherein said feed comprises a sufficiently low amount of protein and amino acids.

11. The method of claim 10, wherein said poultry are ducks or geese.

12. The method of claim 10, wherein said effective amount is effective to accumulate triglycerides in the liver.

13. The method of claim 10, wherein said effective amount is effective to increase deposition of carbohydrates and fats in the liver of said poultry.

14. The method of claim 10, wherein said feed is administered to said poultry without the use of a gavage.

15. The method of claim 10, wherein said feed is administered to said poultry ad litum.

16-19. (canceled)

20. The method of claim 10, further comprising conditioning the poultry by photoperiod manipulation prior to administration to said poultry said feed.

21-24. (canceled)

25. The method of claim 10, wherein said sufficiently low amount of protein is essentially no protein and amino acids.

26. (canceled)

27. A method for changing composition and increasing liver size in poultry, comprising:
conditioning the poultry by photoperiod manipulation
withdrawing feed from said poultry for an appropriate period of time;
subsequently administering to said poultry a feed comprising an effective amount of carbohydrates and fats, such that liver composition is changed and liver size in said poultry is increased, wherein said feed comprises a sufficiently low amount of protein and amino acids.

28. The method of claim 27, wherein said photoperiod manipulation is for at least about 5 days.

29. (canceled)

30. The method of claim 27, wherein said feed is withdrawn from said poultry for at least 12 hours.

31-47. (canceled)
